(19) United States
(12) Patent Application Publication
(10) Pub. No.: US 2026/0176119 A1
(43) Pub. Date: Jun. 25, 2026

(54) COUNTERWEIGHT-BASED GRAVITY OFFLOAD SYSTEM

(71) Applicant: Atlas Devices LLC, Chelmsford, MA (US)

(72) Inventors: Nathan Ball, Forest Grove, OR (US); Daniel Walker, Melrose, MA (US); Gino Kahaunaele, Durham, NC (US)

(21) Appl. No.: 19/424,790

(22) Filed: Dec. 18, 2025

Related U.S. Application Data
(60) Provisional application No. 63/736,243, filed on Dec. 19, 2024.

(51) Int. Cl. B66F 11/00; B64G 7/00

(52) U.S. Cl. CPC B66F 11/00; B64G 7/00

(57) ABSTRACT

Systems and methods simulate reduced-gravity environments using passive counterweight architectures that maintain a substantially constant offload force throughout the user's range of motion. The system may include one or more multi-segment articulated arms, each incorporating a cable routing system that preserves effective cable length during articulation. By routing the cable through coaxial apertures at the joints and through pulley assemblies encapsulated within hollow arm tubes, the offload force remains stable regardless of arm orientation. The system may include a magnetic singularity-avoidance mechanism employing opposed magnets positioned on adjacent arm segments. The magnetic detent biases the arm segments away from singular loading geometries, prevents uncontrolled rotation, and substantially reduces cable twist accumulation. Further embodiments may include gantry-based, trolley-based, or tilting-beam structures for enlarged workspace coverage, and optional friction-offset motors, low-stretch cables, or large-diameter pulleys to minimize hysteresis and maintain greater uniformity of the offload force.

### PRIORITY

This patent application claims priority from provisional U.S. patent application No. 63/736,243, filed Dec. 19, 2024, entitled, “COUNTERWEIGHT-BASED GRAVITY OFFLOAD SYSTEM,” and naming Nathan Ball, Daniel Walker, and Gino Kahaunaele as inventors, the disclosure of which is incorporated herein, in its entirety, by reference.

### FIELD

Illustrative embodiments of the invention generally relate to systems to simulate the effects of reduced gravity and, more particularly, various embodiments of the invention relate to counterweight offload systems.

### BACKGROUND

Exploration of extraterrestrial environments, including the Moon and Mars, presents unique challenges for astronauts, payloads, and the systems designed to operate in these low-gravity environments. To prepare for such missions, it is critical to simulate the effects of reduced gravity (partial gravity) and microgravity in a controlled environment on Earth. These simulations enable effective training, research and development (R&D), operational concept development, and Human-In-The-Loop (HITL) testing to validate equipment, protocols, and mission scenarios. Achieving accurate gravity offloading is essential for replicating the conditions astronauts will experience and ensuring the success of future missions.

Current gravity offloading systems often rely on motorized winches, pools with carefully controlled subject buoyancy, or robotic mechanisms to provide dynamic offload forces that simulate reduced-gravity environments. While effective, these systems are typically complex, costly, and require sophisticated control systems to maintain a consistent offload force. Such systems may also introduce noise or variability in the offload force, particularly during dynamic movements, which can reduce the fidelity of the simulation.

Elastic band-based systems represent another approach for simulating reduced gravity. However, these systems also have limitations, such as varying tension across the range of motion and a lack of precise control over the offload forces. These inconsistencies can make it difficult to replicate specific extraterrestrial gravity levels accurately and reliably.

### SUMMARY OF VARIOUS EMBODIMENTS

In accordance with one embodiment of the invention, a counterweight offload system includes a structural framework, a cable-and-pulley arrangement positioned between a payload attachment interface and operatively coupled to the framework, and a counterweight assembly connected to the cable-and-pulley arrangement. The counterweight assembly is configured to provide a passive offload force to simulate reduced-gravity conditions for at least one user, and the offload force remains substantially uniform throughout a range of motion of the payload without requiring active control systems. A cable is routed through the cable-and-pulley arrangement between the payload attachment interface and the counterweight assembly through a plurality of pulleys.

The counterweight assembly may include a selectable weight stack configured to adjust the offload force to simulate a gravitational environment different from that of Earth. The different gravitational environment may be one of a lunar gravity, a Martian gravity, or a predetermined microgravity.

The structural framework may be moveable, modular, and adapted to support multiple counterweight arms for simultaneous use by two or more users. The system may be operable without external power sources, enabling deployment in remote or outdoor environments.

The counterweight offload system may include auxiliary components including one or more of springs, low-power motors, and heavy-duty cables, the auxiliary components configured to offset frictional losses in the cable-and-pulley arrangement. The cable-and-pulley arrangement may be configured to maintain a substantially constant offload force during dynamic movements of the payload or user.

In accordance with another embodiment of the invention, a gravity-offload apparatus includes a multi-segment articulated arm having a plurality of arm segments connected by rotational joints, a cable routing system that feeds a cable through coaxial apertures of the rotational joints such that articulation of the arm does not substantially change an effective cable path length, a counterweight operatively connected to the cable; and a payload interface connected to the cable. The counterweight may provide a substantially constant offload force independent of arm orientation.

The articulated arm segments may include hollow tubular segments, and the cable may be routed inside of the hollow tubular segments through a plurality of pulleys. The cable routing system may include pulleys of enlarged diameter relative to segment width to minimize hysteresis losses, and stiff cables may be used to minimize hysteresis losses.

The multi-segment articulated arm may include opposed magnetic elements mounted on adjacent arm segments and configured to produce a repulsive bias, and the repulsive bias may inhibit the arm segments from entering a singular alignment and may reduce accumulation of twist in the cable routed through the multi-segment articulated arm. The multi-segment articulated arm comprises two or more rotational joint assemblies. The multi-segment articulated arm configuration may reduce drag during lateral translation of the payload interface, and the rotational joints may be torque-rated structural joint features.

In accordance with another embodiment of the invention, a method for simulating reduced gravity includes suspending a payload from a payload attachment interface coupled to a cable, routing the cable through a cable-and-pulley arrangement and through coaxial apertures in rotational joints of a multi-segment articulated arm, applying a passive counterweight force to the cable, and adjusting an amount of counterweight to replicate a target gravity level. Articulation of the arm does not substantially vary the offload force applied to the payload.

The multi-segment articulated arm may be coupled to a structural framework, the cable-and-pulley arrangement may be positioned between the payload attachment interface and a counterweight assembly may be coupled to the cable-and-pulley arrangement. The counterweight assembly may be configured to provide a passive offload force to simulate reduced-gravity conditions for at least one user.

A friction-offset motor may be coupled to the cable-and-pully arrangement.

In accordance with another embodiment of the invention, a gravity-offload apparatus includes one or more hollow arm segments coupled to a structural framework, one or more pulleys encapsulated within the hollow arm segments, a cable coupled to one or more payload or a user and routed around the pulleys, and a counterweight assembly having at least one counterweight coupled to the cable and the structural framework. The one or more pulleys and the cable forms an internal pulley architecture that maintains a substantially constant offload force while protecting the cable and pulleys from external interference.

The gravity-offload apparatus may include one or more spreader arms. The one or more spreader arms may be configured to enable pivotable attachment to the one or more payload or the user.

The gravity-offload apparatus may include one or more gimbals mounted to the structure. The one or more payload or the user may be configured to be coupled to the one or more gimbals, and the one or more gimbals may be configured to pan and tilt the one or more payload or the user with the at least one counterweight directly counterbalancing the one or more payload or the user. The one or more gimbals comprise 3-axis or 2-axis gimbals.

The gravity-offload apparatus may include a trolley. The structural framework may be coupled to the trolley, and the trolley may be configured to be movably mounted on rails.

In accordance with another embodiment of the invention, a method for simulating reduced-gravity conditions includes suspending a payload or user from a cable routed through a pulley system, applying a passive counterweight force to the cable to offset at least a portion of the payload or user's weight, and adjusting the counterweight force by adding or removing weights to replicate a target gravitational environment.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 shows a counterweight offload system in accordance with illustrative embodiments.

FIG. 2 shows another counterweight offload system in accordance with illustrative embodiments.

FIG. 3 shows an expansion-view of the counterweight offload system of FIG. 2 in accordance with illustrative embodiments.

FIG. 4A shows a schematic drawing illustrating the effect of magnets incorporated into articulated segments in accordance with illustrative embodiments.

FIG. 4B shows a schematic drawing illustrating the effect of magnets incorporated into articulated segments in accordance with illustrative embodiments.

FIG. 5 shows another counterweight offload system in accordance with illustrative embodiments.

FIG. 6 shows steps of an embodiment of a method for simulating reduced gravity in accordance with illustrative embodiments.

FIG. 7 shows steps of an embodiment of a method for simulating reduced-gravity conditions in accordance with illustrative embodiments.

### DESCRIPTION OF ILLUSTRATIVE EMBODIMENTS

Details of illustrative embodiments are discussed below. Illustrative embodiments relate to systems and methods for simulating reduced-gravity environments using passive counterweight architectures that maintain a substantially constant offload force throughout the user's range of motion. In various embodiments, the system includes one or more multi-segment articulated arms, each incorporating a cable routing system that preserves effective cable length during articulation. By routing the cable through coaxial apertures at the joints and through pulley assemblies encapsulated within hollow arm tubes, the offload force remains stable regardless of arm orientation.

In certain embodiments, the system further includes a magnetic singularity-avoidance mechanism employing opposed magnets positioned on adjacent arm segments. The magnetic detent biases the arm segments away from singular loading geometries, prevents uncontrolled rotation, and substantially reduces cable twist accumulation.

Further embodiments include gantry-based, trolley-based, or tilting-beam structures for enlarged workspace coverage. The system may include optional friction-offset motors, low-stretch cables, or large-diameter pulleys to minimize hysteresis and maintain greater uniformity of the offload force.

The invention therefore provides a passive, mechanically predictable, energy-independent offload platform suitable for astronaut training, spacesuit development, payload handling, Human-In-The-Loop (HITL) studies, and other reduced-gravity simulation requirements.

The system described herein utilizes passive counterweights to offset the weight of an astronaut or payload. By employing a system of cables and pulleys within a movable structure, the weight of the counterbalance is used to provide the desired offload force. The force can be adjusted by adding or removing dead weights on the counterweight side of the cable. This approach offers a simpler, more cost-effective, and reliable alternative to motorized or elastic systems for simulating reduced-gravity environments.

The disclosed counterweight-based offloading system of various embodiments offers several benefits to users.
1. Precision and Consistency: The passive counterweight system delivers a stable and predictable offload force across the entire range of motion. Unlike elastic systems, which vary in tension as they stretch, or motorized systems that require complex feedback loops, this approach ensures uniformity. This consistency is critical for accurate simulation of reduced-gravity environments, improving the fidelity of astronaut training and payload handling. Consistent force application is critical for accurate simulation of lunar, Martian, or microgravity conditions, enabling precise training and testing without introducing variability that could compromise mission readiness.
2. Ease of Adjustment: The system incorporates a selectable weight stack mechanism, similar to those found in commercial fitness equipment. This design allows quick and intuitive adjustments to simulate different gravitational conditions—such as 1/6G for lunar missions, 1/3G for Mars, or full offload for microgravity scenarios. Users can change settings without specialized tools or technical expertise, reducing setup time and increasing operational flexibility.
3. Scalability and Versatility: The architecture supports a wide range of payloads and astronaut body weights, making it suitable for diverse applications including research and development, operational testing, and crew training. The modular design enables multiple arms to be added, allowing simultaneous training for two or more astronauts. This scalability enhances team-based mission preparation and collaborative task simulations, ensuring broad applicability across space programs and analog environments.
4. Reduced Complexity: Unlike motorized systems that require electrical power, control electronics, and routine servicing, this passive system minimizes complexity. Its mechanical simplicity translates into lower maintenance costs, greater reliability, and ease of deployment in remote environments where power sources may be unavailable—such as desert terrains for geological training exercises.
5. Enhanced Realism and Training Effectiveness: By providing a consistent and gravity-accurate offload force, the system improves the realism of simulated environments. This leads to better muscle memory development, more accurate task rehearsals, and higher confidence during actual missions. Compared to static or elastic offload systems, this approach offers superior fidelity for dynamic movements and operational tasks.
6. Energy Independence and Field Deployability: The passive nature of the system eliminates reliance on external power, making it ideal for outdoor or austere environments. This capability supports extended training sessions in analog mission sites without logistical constraints related to power supply.
7. Optional Performance Enhancements: While the core system remains simple and robust, optional add-ons—such as small motors or springs—can be integrated to offset frictional losses in the cable routing system. These enhancements preserve the primary benefits of simplicity and reliability while offering incremental performance improvements in performance for specialized applications.
8. Preferred Mechanical Design for Mobility: The double-jib arm configuration with pulley-routed cables minimizes drag during lateral translation of the suspension point. This feature is particularly important in low-gravity simulations (e.g., 1/6G lunar environments), where reduced ground reaction forces make sideways movement more challenging. The design ensures smooth, realistic mobility without compromising structural integrity, enhancing the authenticity of training exercises.

To further enhance performance, additional devices such as springs or small motors may be incorporated to counteract frictional losses in the cable routing system. However, the primary source of offload force remains the counterweights, preserving the simplicity and reliability of the system.

While other methods of routing the counterweight cable or rope may be reasonably accomplished using movable gantry or jib crane approaches, or even a direct mechanical counterbalance approach such as a “Jimmy Jib” crane used in the movie industry to counterbalance and move a camera on a long arm, the double jib arm with cables routed through the arms via pulleys is a preferred approach due to its mechanical simplicity and minimal drag when translating the suspension point laterally, which becomes especially important in a 1/6G environment due to the reduced ground reaction forces that prevent a user's feet from pushing as hard laterally against the ground to move sideways as can be done in other gravitational/offload environments like 1/3G or 1G.

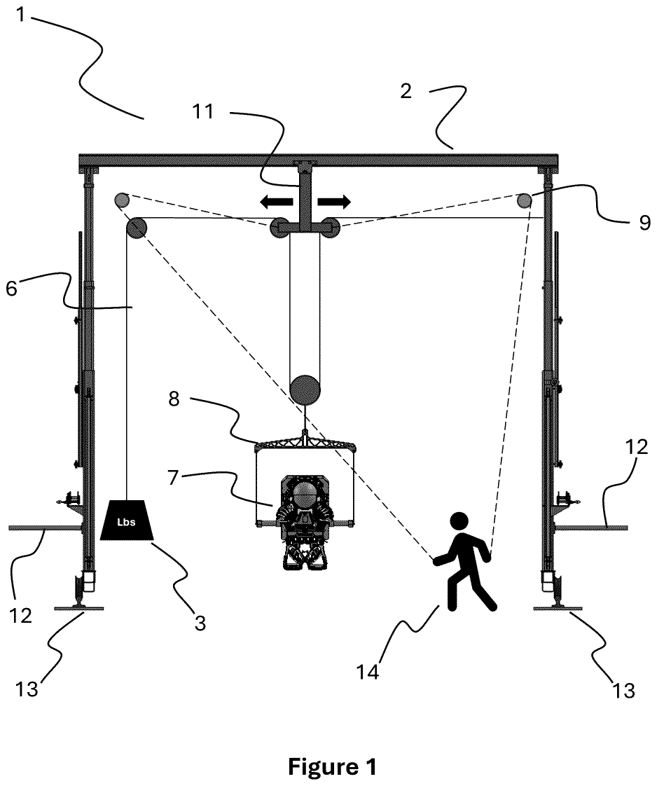

In an embodiment shown in FIG. 1, a counterweight-based offload system 1 is comprised of a structural framework (e.g., structure) 2 such as a gantry crane mounted movably on rails 13, with a movable carriage 11. Pulleys 9 allow an operator 14 to assist a user (e.g., an astronaut) 7 to move about in the x-direction, which in FIG. 1 is in the plane of the page with the assistance of the operator 14. In some embodiments, a payload may be positioned in the location of the user 7 in FIG. 1.

A counterweight 3 is coupled to a cable 6 that is part of a cable-and-pulley arrangement that is positioned between the payload 3 and the structural framework 2. A spreader arm 8 may be used to enable pivotable attachment to the payload or astronaut 7 by attaching cables 6 directly or through a gimbal to a point as close as possible to the payload or center of mass of the astronaut 7, thereby reducing the effect of moments imparted about the center of mass by the offload force.

The moveable carriage 11 can be moved with pulleys 9 configured such that an operator 14 can manually move the carriage side-to-side between the legs of the structure. In this way, an operator can move the carriage 11 side-to-side without affecting the vertical position of the counterweight 3 or the user 7. The user 7 is free to move about in the x-direction, which in FIG. 1 is in the plane of the page with the assistance of the operator 14.

The user 7 may move up and down in the z-direction, which in FIG. 1 is in the plane of the page. As the user 7 moves down to sit or reach for something on the ground, the user 7 has an amount of her weight off-loaded by the counterweight.

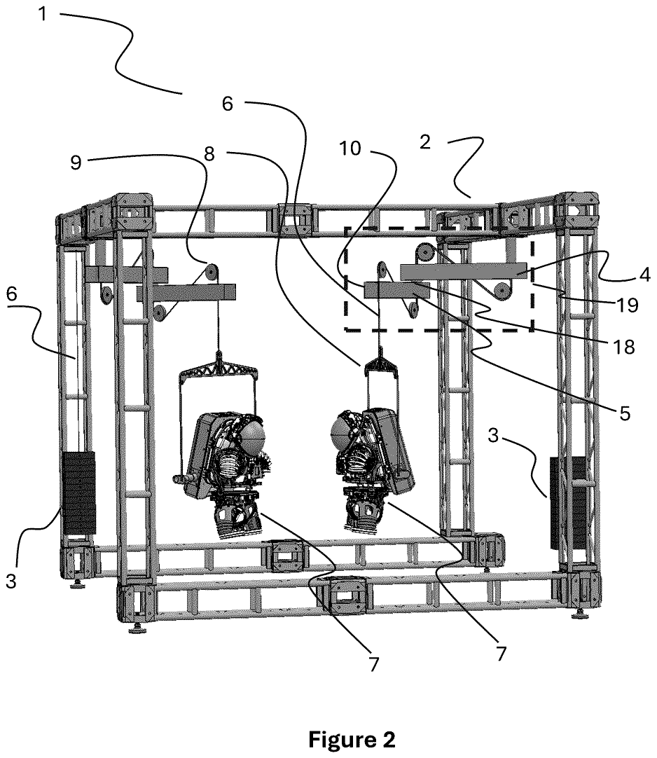

A set of bars 12 affixed to the structure 2 can enable additional operators to move the entire gantry structure 2 in a y-direction, which in FIG. 1 is into and out of the plane of the page with the assistance of the additional operators by pushing on the bars. By staying in sync with the astronaut or payload 7's motion, the overhead suspension point on the carriage 11 can be kept over the astronaut or position of the payload 7, thereby maintaining a constant offload force across a rectangular work area instead of a circular one such as what is enabled by an embodiment shown in FIG. 2.

In an embodiment shown in FIG. 2, a counterweight offload system 1 is comprised of a structure 2, with cable 6 attached at one end to passive counterweights 3, and to a payload, human, or space suit 7 at the other end. The cable 6 is routed from the counterweights 3 through a system of pulleys 9 (e.g., cable-and-pulley arrangement) attached to the structure 2 and a double-segment articulated arm including segments 4 and 5. While a double-segment articulated arms are illustrated in FIG. 2, in some embodiments the articulated arms can be triple pivoting arms or more. The cable 6 passes through the cable routing system (e.g., cable-and-pulley arrangement) from segment 4 to segment 5 through a coaxial aperture of a rotational joint assembly 18 such that articulation of the segment arm does not substantially change an effective cable path length. In this way, a user 7 may move in the x-y plane of the surface without applying an upward or downward force to the counterweight 3.

A spreader arm 8 may be used to enable pivotable attachment to the payload or astronaut 7 by attaching cables directly or through a gimbal to a point as close as possible to the payload or astronauts 7 center of mass, thereby reducing the effect of moments imparted about the center of mass by the offload force. Springs or a small motor may also be attached to the structure to impart additional forces on the cable 6 or astronaut/payload 7 to reduce or counteract the effects of friction and drag in the system from the pulleys. One such location can be between the distal end 10 of the second pivoting arm 5 and the spreader arm 8.

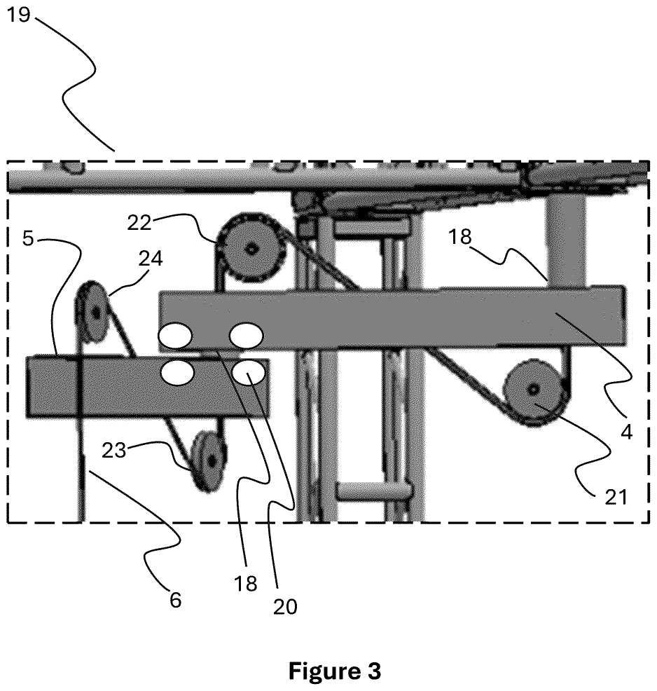

FIG. 3 shows an expanded view 19 of a portion of FIG. 2. The cable 6 travels a path through the cable-and-pulley arrangement from a first pulley 21 below the segment arm 4 to a second pulley 22, by passing through the segment arm 4. The cable 6 then passes from the second pulley 22 through the coaxial aperture of the rotational joint assembly 18 to third pulley 23, and then passes through segment arm 5 to fourth pulley 24.

In some embodiments, the cable-and-pulley arrangement may be contained within hollow tubular articulated arm segments, and the cable may be routed inside of the hollow tubular segments through a plurality of pulleys. The cable routing system may include pulleys of enlarged diameter relative to segment width to minimize hysteresis losses, and stiff cables may be used to minimize hysteresis losses.

In some embodiments, a multi-segment articulated arm may include three arm segments connected by rotational joint assemblies. A cable may be routed through coaxial apertures in the rotational joint assemblies and through internal pulleys encapsulated within the hollow arm segments. The cable may connect a payload interface to a counterweight assembly. Because the cable path length remains constant during articulation, the counterweight provides a substantially uniform offload force regardless of arm orientation.

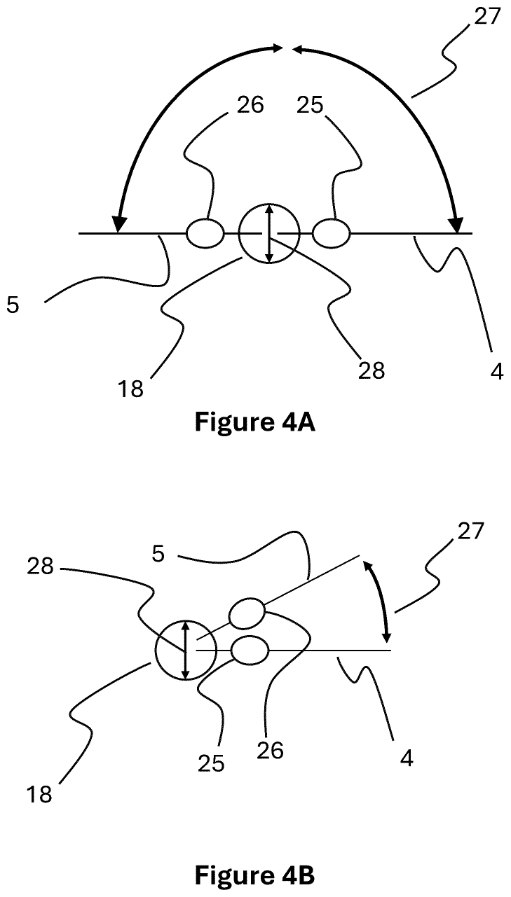

FIGS. 4A and 4B show the rotational joint assembly 18 including two adjacent arm segments 4, 5 and a magnetic detent system comprising opposed permanent magnets 25, 26. The magnets are arranged so as to generate a repulsive force 27 that biases the joint away from colinear alignment. A central aperture 28 permits coaxial routing of a cable 6. The repulsive bias prevents singularities and reduces twist accumulation in the cable 6.

The multi-segment articulated arm may include two or more rotational joint assemblies (e.g., rotational joints) 18. The multi-segment articulated arm configuration may reduce drag during lateral translation of the payload interface, and the rotational joint assemblies 18 may be torque-rated structural joint features.

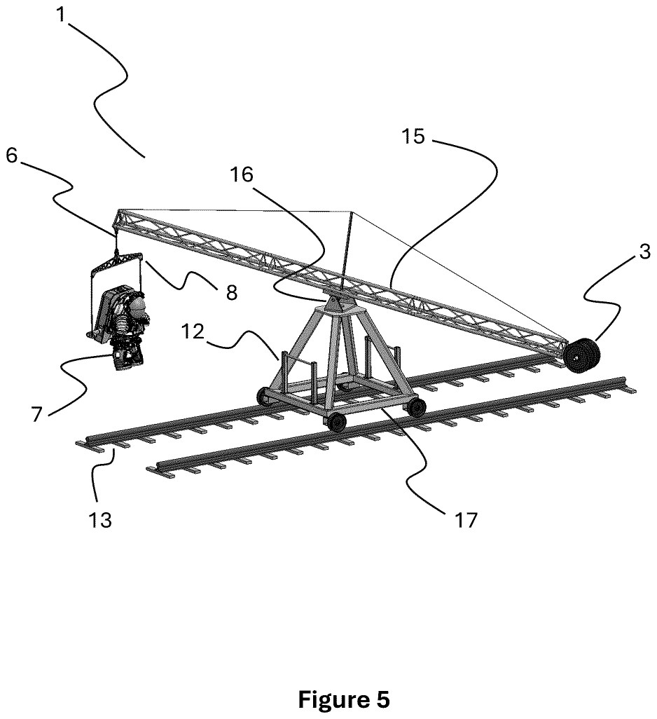

In some embodiments, a counterweight offload system 1 is comprised of a trolley 17 mounted movably on rails 13 that can be pushed back and forth by an operator via pushing bars 12, as shown in FIG. 5. A beam 15 is mounted via a gimbal 16 to the trolley 17 such that it can pan and tilt, with counterweights 3 directly counterbalancing the astronaut or payload 7, which can be connected to the beam 15 via additional devices such as a cable 6 and spreader bar/gimbal 8. By attentively moving the trolley 17 to match the astronaut or payload 7's motion, an operator can enable an offload-enabled work area with yet another approach of passive counterweight offloading.

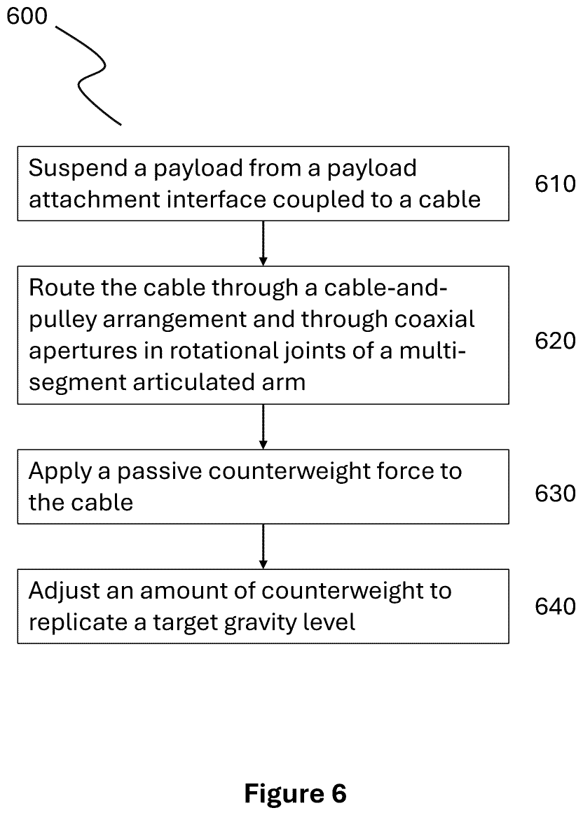

FIG. 6 shows a method 600 for simulating reduced gravity in one embodiment. It should be noted that this method is substantially simplified from a longer process that may normally be used. Accordingly, the method shown in FIG. 6 may have many other steps that those skilled in the art likely would use. In addition, some of the steps may be performed in a different order than that shown, or at the same time. Furthermore, some of these steps may be optional in some embodiments. Accordingly, the process 600 is merely exemplary of one process in accordance with illustrative embodiments of the invention. Those skilled in the art therefore can modify the process as appropriate.

At step 610, a payload is suspended from a payload attachment interface coupled to a cable. Payloads can be mounted to the cables through several common attachment interfaces, each suited to different mechanical and operational requirements. Hook and shackle interfaces may be used, offering quick connection in the case of hooks or secure, high-strength fastening with shackles. Fixed-eye and swivel-eye pulleys provide a compact attachment point for carabiners, bolts, or slings; swivel eyes additionally prevent torsional buildup in the line.

Optional connections also include bolt-on and through-bolt mounts, as well as soft attachments such as webbing straps or soft shackles. Also, snatch-block or snap-open interfaces allow the rope to be installed without disconnecting the pulley from its anchor, improving efficiency and safety during dynamic or repetitive rigging operations.

At step 620, the cable is routed through a cable-and-pulley arrangement and through coaxial apertures in rotational joints of a multi-segment articulated arm. The cable routing may involve guiding the cable so it maintains proper alignment, tension, and wrap around each pulley without introducing unnecessary friction or bending stresses. The cable may enter the cable-and-pulley system through a rotational joint assembly attached to the structure where it is routed to the first pulley, and then through the cable-and-pulley system.

Once the cable path is established across all pulleys, tensioning may be performed to remove slack and ensure stable tracking. Proper tension is maintained because too little tension may allows the cable to jump tracks or oscillate, while excessive tension accelerates wear on both the cable and the bearings. The cable-and-pulley system may include idler pulleys, or spring-loaded mechanisms to accommodate thermal expansion, dynamic loading, and/or structural deflection in the system. Throughout operation, the cable remains seated fully within the pulley groove, and the pulleys must rotate freely without binding, ensuring smooth load transfer and minimizing energy loss. The pulleys may have enlarged diameters relative to segment width to minimize hysteresis losses. Stiff cables may also be used to minimize hysteresis losses.

At step 630, a passive counterweight force is applied to the cable. The counterweight may be a stack of weights attached to the structure that is coupled to the cable-and-pulley system. The counterweight may be directly counterbalancing the astronaut or payload by being connected to a beam.

At step 640, an amount of counterweight is adjusted to replicate a target gravity level. The counterweight may be a column of stacked weights which can be engaged and adjusted to match the predetermined, target gravitational environment with mechanical pins, hooks, and the like.

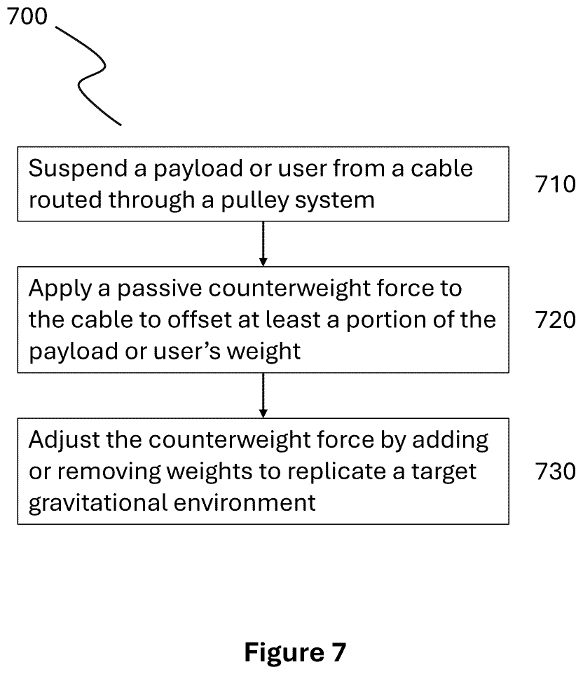

FIG. 7 shows a method 700 for simulating reduced-gravity conditions in an embodiment. It should be noted that this method is substantially simplified from a longer process that may normally be used. Accordingly, the method shown in FIG. 7 may have many other steps that those skilled in the art likely would use. In addition, some of the steps may be performed in a different order than that shown, or at the same time. Furthermore, some of these steps may be optional in some embodiments. Accordingly, the process 700 is merely exemplary of one process in accordance with illustrative embodiments of the invention. Those skilled in the art therefore can modify the process as appropriate.

At step 710, a payload or user is suspended from a cable routed through a pulley system. The payload or user may be attached via spreader arm which may be used to enable pivotable attachment to the payload or astronaut by attaching cables directly or through a gimbal to a point as close as possible to the payload or center of mass of the astronaut or payload. This attachment method may reduce the effect of moments imparted about the center of mass by the offload force.

At step 720, a passive counterweight force is applied to the cable to offset at least a portion of the payload or user's weight. The counterweight provides a passive force that can be used to offset or counter a predetermined amount of gravitational force to simulate a lower gravitational environment.

At step 730, the counterweight force is adjusted by adding or removing weights to replicate a target gravitational environment. The counterweight may be a column of stacked weights which can be engaged and adjusted with mechanical pins, hooks, and the like.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A counterweight-based gravity offload system, comprising:
a structural framework;
a cable-and-pulley arrangement positioned between a payload attachment interface and operatively coupled to the framework; and
a counterweight assembly connected to the cable-and-pulley arrangement, the counterweight assembly configured to provide a passive offload force to simulate reduced-gravity conditions for at least one user, the offload force remaining substantially uniform throughout a range of motion of the payload without requiring active control systems; and
a cable being routed through the cable-and-pulley arrangement between the payload attachment interface and the counterweight assembly through a plurality of pulleys.

2. The system of claim 1, wherein the counterweight assembly comprises a selectable weight stack configured to adjust the offload force to simulate a different gravitational environment from that of Earth.

3. The system of claim 2, wherein the different gravitational environment is one of a lunar gravity, a Martian gravity, or a predetermined microgravity.

4. The system of claim 1, wherein the structural framework is moveable, modular, and adapted to support multiple counterweight arms for simultaneous use by two or more users.

5. The system of claim 1, wherein the system is operable without external power sources, enabling deployment in remote or outdoor environments.

6. The system of claim 1, further comprising:
auxiliary components including one or more of springs, low-power motors, and heavy-duty cables, the auxiliary components configured to offset frictional losses in the cable-and-pulley arrangement.

7. The system of claim 1, wherein the cable-and-pulley arrangement is configured to maintain a substantially constant offload force during dynamic movements of the payload or user.

8. A counterweight-based gravity offload apparatus, comprising:
a multi-segment articulated arm having a plurality of arm segments connected by rotational joints;
a cable routing system that feeds a cable through coaxial apertures of the rotational joints such that articulation of the arm does not substantially change an effective cable path length;
a counterweight operatively connected to the cable; and
a payload interface connected to the cable,
wherein the counterweight provides a substantially constant offload force independent of arm orientation.

9. The apparatus of claim 8, wherein:
the arm segments comprise hollow tubular segments; and
the cable is routed inside of the hollow tubular segments through a plurality of pulleys.

10. The apparatus of claim 9, wherein the cable routing system includes pulleys of enlarged diameter relative to segment width to minimize hysteresis losses.

11. The apparatus of claim 8, wherein stiff cables are used to minimize hysteresis losses.

12. The apparatus of claim 8, wherein:
the multi-segment articulated arm comprises opposed magnetic elements mounted on adjacent arm segments and configured to produce a repulsive bias; and
the repulsive bias inhibits the arm segments from entering a singular alignment and reduces accumulation of twist in the cable routed through the multi-segment articulated arm.

13. The apparatus of claim 8, wherein the multi-segment articulated arm comprises two or more rotational joint assemblies.

14. The apparatus of claim 8, wherein the multi-segment articulated arm configuration reduces drag during lateral translation of the payload interface.

15. The apparatus of claim 8, wherein the rotational joints are torque-rated structural joint features.

16. A method for simulating reduced gravity, comprising:
suspending a payload from a payload attachment interface coupled to a cable;
routing the cable through a cable-and-pulley arrangement and through coaxial apertures in rotational joints of a multi-segment articulated arm;
applying a passive counterweight force to the cable; and
adjusting an amount of counterweight to replicate a target gravity level,
wherein articulation of the arm does not substantially vary the offload force applied to the payload.

17. The method of claim 16, wherein:
the multi-segment articulated arm is coupled to a structural framework;
the cable-and-pulley arrangement is positioned between the payload attachment interface and a counterweight assembly coupled to the cable-and-pulley arrangement;
the counterweight assembly is configured to provide a passive offload force to simulate reduced-gravity conditions for at least one user.

18. The method of claim 17, wherein a friction-offset motor is coupled to the cable-and-pully arrangement.

19. A counterweight-based gravity offload apparatus, comprising:
one or more hollow arm segments coupled to a structural framework;
one or more pulleys encapsulated within the hollow arm segments;
a cable coupled to one or more payload or a user and routed around the pulleys; and
a counterweight assembly having at least one counterweight coupled to the cable and the structural framework,
wherein the one or more pulleys and the cable forms an internal pulley architecture that maintains a substantially constant offload force while protecting the cable and pulleys from external interference.

20. The apparatus of claim 19, further comprising:
one or more spreader arms, the one or more spreader arms configured to enable pivotable attachment to the one or more payload or the user.

21. The apparatus of claim 19, further comprising:
one or more gimbals mounted to the structure, wherein:
the one or more payload or the user is configured to be coupled to the one or more gimbals; and
the one or more gimbals are configured to pan and tilt the one or more payload or the user with the at least one counterweight directly counterbalancing the one or more payload or the user.

22. The apparatus of claim 21, wherein the one or more gimbals comprise 3-axis or 2-axis gimbals.

23. The apparatus of claim 19, further comprising:
a trolley, wherein the structural framework is coupled to the trolley; and
the trolley is configured to be movably mounted on rails.

24. A method for simulating reduced-gravity conditions, comprising:
suspending a payload or user from a cable routed through a pulley system;
applying a passive counterweight force to the cable to offset at least a portion of the payload or user's weight; and
adjusting the counterweight force by adding or removing weights to replicate a target gravitational environment.
